(19) United States
(12) Patent Application Publication
(10) Pub. No.: US 2004/0176996 A1
(43) Pub. Date: Sep. 9, 2004

(54) Method for monitoring a managed system

(76) Inventors: Jason Powers, Santa Monica, CA (US); Mark L. Sabiers, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/379,179

(22) Filed: Mar. 3, 2003

(51) Int. Cl. G06F 17/60

(52) U.S. Cl. 705/11

(57) ABSTRACT

A method for monitoring a managed system. A performance requirement comprising at least one condition and at least one consequence is received, wherein the condition describes a required performance level of the managed system and the consequence describes a penalty provided the required performance level is not satisfied. System management data of the managed system pertaining to the condition is monitored for an instance of a threshold of the required performance level not being satisfied. In response to the threshold not being satisfied, a notification is generated.

### FIELD OF INVENTION

Various embodiments of the present invention relate to the field of managed systems.

### BACKGROUND OF THE INVENTION

As the use of computing technology continues to expand in the business world, managed systems such as distributed computer networks and enterprise systems are becoming more prevalent. In general, a managed system is a computing system that collects data against its own execution, and uses the data to manage its operation. A typical managed system is an enterprise system implementing Web services.

Managed systems typically comprise a distributed system of independent threads of execution. In the event of an execution problem, the data can be used to perform an analysis and report on the problem. Often, managed systems are so distributed and complex that people in different roles are responsible for managing and monitoring different aspects of the managed system.

For example, a distributed collection of computer servers may be used to back a shopping Web site. In managing a typical shopping Web site, people with a number of different roles are employed. Often, business managers, information technology (IT) personnel/operators and software developers all concerned with the state or performance of a system. In order to guarantee performance of different aspects of the Web site, service level agreements (SLAs) are typically executed between the different roles.

A SLA is a contract between a provider and a user that specifies the level of performance/service that is expected during its term. SLAs may be used by vendors and customers as well as internally by information technology (IT) divisions of an organization and their end users within the organization. For example, an SLA may specify bandwidth availability, response times for routine and ad hoc queries, response time for problem resolution (e.g., network down, machine failure) as well as attitudes and consideration of the technical staff. Furthermore, SLAs often include the consequences of a breach of the level of performance, such as a monetary penalty.

Web sites backed by Web services typically employ SLAs between different roles. For example, business management may have one or more SLAs with IT personnel guarantying Web site performance. In turn, the IT personnel may have one or more SLAs with software developers to guarantee performance of different software components of the Web site.

Currently, SLAs are typically written agreements between different roles that are not enforced systematically. In particular, SLAs are often haphazard and hard to monitor due to the lack of automation. While SLA performance may be measured by performing a manual audit, they are often difficult to enforce due to lack of access to pertinent data. For example, a business manager may not be aware of how the business process maps to operations. Current enforcement policies require manual auditing, are costly and time consuming, and are often difficult to execute due to the lack of key data.

### SUMMARY OF THE INVENTION

Various embodiments of the present invention, a method for monitoring a managed system, are presented. A performance requirement comprising at least one condition and at least one consequence is received. In one embodiment, the condition describes a required performance level of the managed system and the consequence describes a penalty provided the required performance level is not satisfied. System management data of the managed system pertaining to the condition is monitored for an instance of a threshold of the required performance level not being satisfied. In response to the threshold not being satisfied, a notification is generated.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a managed system in accordance with one embodiment of the present invention.

FIG. 2 is a flowchart illustrating a process for monitoring a managed system in accordance with one embodiment of the present invention.

FIG. 3 is a flowchart illustrating a process for determining whether a threshold is satisfied in accordance with one embodiment of the present invention.

FIG. 4A is a block diagram of an exemplary business process view illustrating line of business service level agreements (SLAs) in accordance with one embodiment of the present invention.

FIG. 4B is a block diagram of an exemplary information technology (IT) view illustrating line of IT SLAs in accordance with one embodiment of the present invention.

FIG. 4C is a block diagram of an exemplary developer view illustrating developer SLAs in accordance with one embodiment of the present invention.

### BEST MODE(S) FOR CARRYING OUT THE INVENTION

Reference will now be made in detail to various embodiments of the invention, examples of which are illustrated in the accompanying drawings. While the invention will be described in conjunction with various embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention. However, it will be apparent to one skilled in the art that the present invention may be practiced without these specific details. In other instances, well-known methods, procedures, components, structures and devices have not been described in detail so as to avoid unnecessarily obscuring aspects of the present invention.

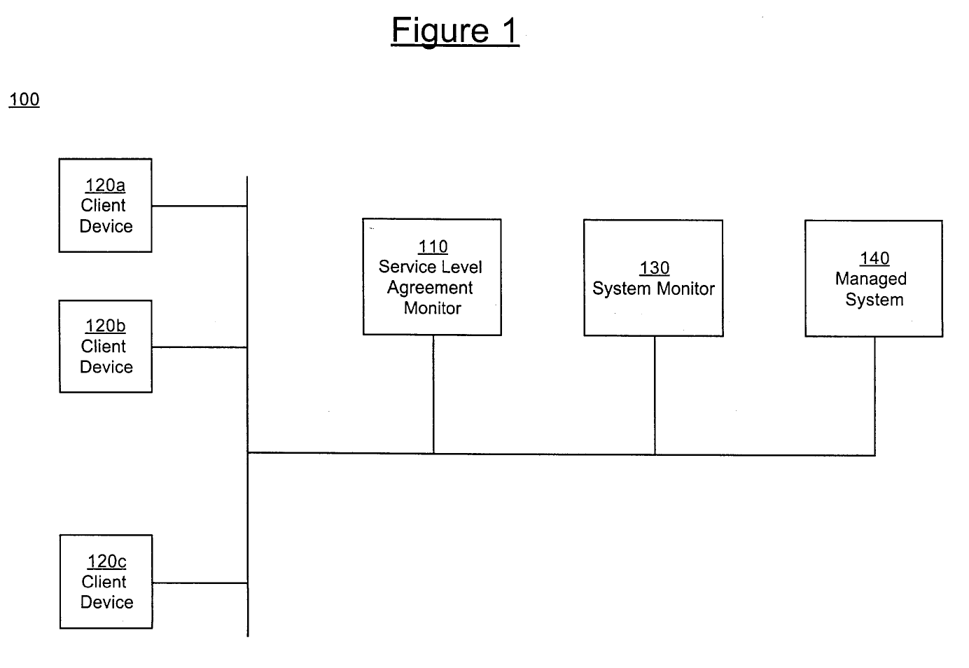

FIG. 1 is a block diagram of distributed computer network 100 in accordance with one embodiment of the present invention. Distributed computer network 100 comprises service level agreement (SLA) monitor 110, client devices 120a-c, system monitor 130, and managed system 140. It should be appreciated that distributed computer network 100 includes well know network technologies. For example, distributed computer network 100 can be implemented using local area network (LAN) technologies (e.g., Ethernet, Tokenring, etc.), the Internet, or other wired or wireless network technologies. The communications links between SLA monitor 110, client devices 120a-c, system monitor 130, and managed system 140 over distributed computer network 100 can be implemented using, for example, a telephone circuit, communications cable, optical cable, wireless link, or the like.

In one embodiment, managed system 140 is a computing system wherein data is collected against execution and is used to manage operation of the computing system. In one embodiment, managed system 140 is an enterprise system operable to provide Web services. In one embodiment, the Web services back a shopping Web site. In one embodiment, the managed system is monitored by a plurality of roles of users. For example, in the present embodiment, business managers may be interested in the business aspects of system performance, information technology (IT) operators may be interested in operations aspects of system performance, and software developers may be interested in the development aspects of system performance.

In one embodiment, system monitor 130 collects system management data from managed system 140. The system management data is collected against the execution of managed system 140, and the system management data is used to manage the operation of managed system 140. It should be appreciated that system monitor may be configured to retrieve any system management data. System management data is any data that can be used to determine the performance of managed system 140. For example, response time of managed system 140 can be used as an indicator of performance. If the response time is low, managed system 140 may require additional computing resources to improve the response time.

Client devices 120a-c are operable to provide a user with access to SLA monitor 110, system monitor 130, or managed system 140. In one embodiment, users of different roles have access to distributed computer network 100. For example, client device 120a may be accessible to a business manager in a business role, client device 120b may be accessible to an IT operator in an IT role, and client device 120c may be accessible to a software developer in a development role. It should be appreciated that client devices 120a-c may be any electronic device used for communicating electronically, such as a computer system.

Embodiments of the present invention are directed towards systematic management of the relationships between the different roles. In one embodiment, a SLA is used to dictate the service relationship between different roles. In one embodiment, a SLA is a contract between a provider and a user that specifies a condition (e.g., the level of performance/service) that is expected during its term. A SLA may also dictate the consequences in the event that the level of performance is not met.

SLA monitor 110 is configured to receive conditions associated with a SLA between at least two roles. In one embodiment, SLA monitor 110 is configured to receive a performance requirement comprising at least one condition and at least one consequence. The condition describes a required performance level of a portion of managed system 140 and the consequence describes a penalty incurred by the provider if the required performance level is not satisfied. In one embodiment, SLA monitor 110 stores the conditions in a database.

It should be noted that embodiments of the present invention are implemented as a software based process cooperatively executing on the respective computer system platforms of both SLA monitor 110 and clients 120a-c.

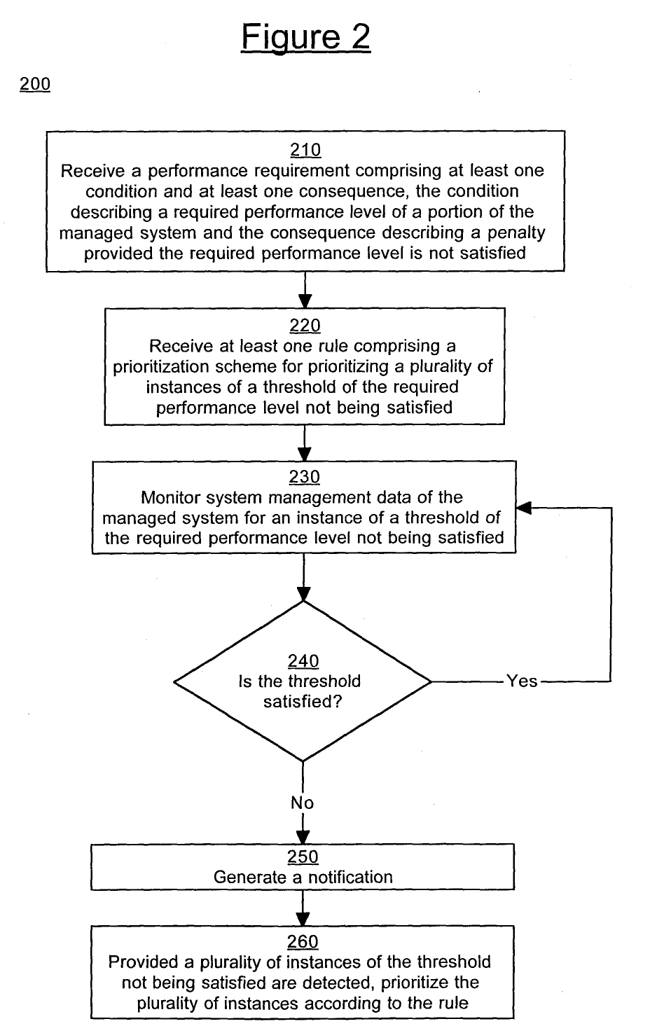

FIG. 2 is a flowchart illustrating a process 200 for monitoring a managed system in accordance with one embodiment of the present invention. In one embodiment, process 200 is carried out by processors and electrical components under the control of computer readable and computer executable instructions. Although specific steps are disclosed in process 200, such steps are exemplary. That is, the embodiments of the present invention are well suited to performing various other steps or variations of the steps recited in FIG. 2.

At step 210, a performance requirement comprising at least one condition and at least one consequence are received. In one embodiment, the performance requirement is comprised within a SLA. In one embodiment, the SLA is between a business role and a development role. The condition describes a required performance level of a portion of the managed system. For example, the condition may require a performance level wherein response time is less than two seconds. The consequence describes a penalty incurred by the provider provided the required performance level is not satisfied. For example, for every response time over two seconds, five cents is deducted from the payment due the provider.

In one embodiment, the condition is received at a SLA monitor (e.g., SLA monitor 110 of FIG. 1). In one embodiment, a user inputs the condition into a client device (e.g., client device 120 of FIG. 1) connected to the SLA monitor. In another embodiment, a provider inputs the condition into a client device connected to the SLA monitor.

In one embodiment, a threshold of the required performance level is received. In one embodiment, the threshold is the required performance level of the condition. In another embodiment, the threshold is associated with the required performance level of the condition. In the present embodiment, the threshold is pre-determined by a provider such that a warning may be received prior to the required performance level satisfaction failure. For example, consider a condition requiring a response time of less than two seconds. In order to ensure that the response time never gets above two seconds, a provider may set the threshold level at 1.5 seconds. A notification will be generated when a response is greater than 1.5 seconds, warning the provider that the condition is at risk of not being satisfied. As such, the present embodiment provides for allowing a provider to receive a warning prior to the violation of a required performance level.

At step 220, at least one rule is received. In one embodiment, the rule comprises a prioritization scheme for prioritizing a plurality of instances of the threshold not being satisfied. It should be appreciated that embodiments of the present invention are directed towards continuous monitoring of a managed system for a violation of a required performance level. Furthermore, it should be appreciated that step 220 is optional, and provides further management of conditions and SLAs.

In one embodiment, a threshold of a required performance level may be violated a plurality of times. For example, consider a managed system that implements Web services to run a shopping Web site. A SLA of the managed system comprises a condition with a required performance level of processing an order in less than twelve hours and a consequence of 10% of the cost of the order. Two orders (e.g., instances) are received, and the processing of both orders simultaneously will result in the required performance level being violated for both. The rule may prioritize the violations by indicating that the most expensive order will be handled first, minimizing the financial cost the provider must incur.

At step 230, system management data of the managed system is monitored for an instance of a threshold of the required performance level not being satisfied. In one embodiment, the system management data is retrieved from a system monitor (e.g., system monitor 130 of FIG. 1). It should be appreciated that system management data is any data than can be used to gauge the performance of a managed system. In one embodiment, the system management data associated with a condition is accessed. In other words, only the system management data relevant for a particular condition is accessed. For example, if a condition has a required performance level of a two second response time, the system management data that is used to determine the response time is accessed. It may be unnecessary to access system management data not used to determine response time.

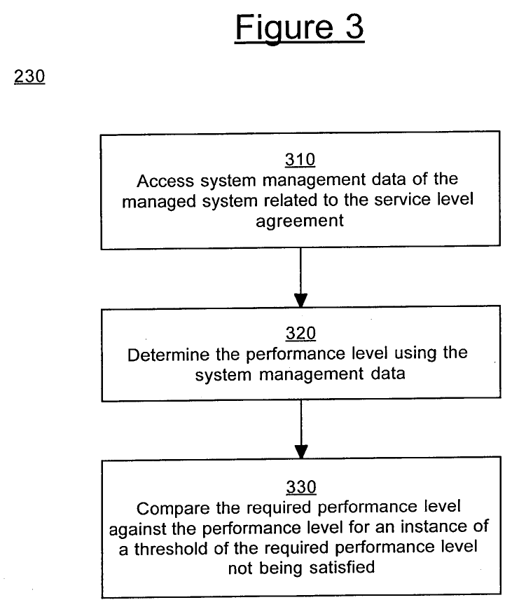

FIG. 3 is a flowchart illustrating a process for determining whether a threshold is satisfied in accordance with one embodiment of the present invention. In one embodiment, process 300 is carried out by processors and electrical components under the control of computer readable and computer executable instructions. Although specific steps are disclosed in process 230, such steps are exemplary. That is, the embodiments of the present invention are well suited to performing various other steps or variations of the steps recited in FIG. 3.

At step 310 of process 230, system management data of the managed system related to the condition is accessed. As described above, in one embodiment of the present invention, the system management data is retrieved from a system monitor (e.g., system monitor 130 of FIG. 1). It should be appreciated that system management data is any data than can be used to gauge the performance of a managed system. However, only access of system management data needed to determine whether the required performance level has been violated is required.

At step 320, a performance level of the portion of the managed system is determined based on the system management data related to required performance level of the condition. It should be appreciated that determination of the performance level of a particular portion of a managed system is known in the art, and varies depending on the portion. For example, consider a SLA that limits a provider to handling 500 transactions in a day, and that transactions over 500 are performed at an additional cost to the user. In order to determine the performance level of the SLA, the total number of transactions performed by the provider is determined.

At step 330, the required performance level is compared against the system management data for an instance of a threshold of the required performance level not being satisfied. Continuing with the example described at step 320, if the performance level indicates that 500 or fewer transactions have been handled by the provider, the required performance level is determined to be satisfied. Alternatively, if the performance level indicates that the provider has handled more than 500 transactions, the required performance level is determined to not be satisfied. In one embodiment, this determination is forwarded to step 240 of FIG. 2.

With reference to FIG. 2, at step 240 of process 200, it is determined whether the threshold has been satisfied. Provided the threshold has been satisfied, process 200 returns to step 230, continuing to monitor the system management data. Alternatively, provided the threshold has not been satisfied, process 20 proceeds to step 250.

At step 250, a notification (e.g., an alert) is generated in response to the threshold not being satisfied. In one embodiment, where the threshold is the required performance level, the notification indicates a violation of the condition. In another embodiment, where the threshold is associated with the required performance level, the notification provides a warning that the required performance level is approaching a breach. In one embodiment, the notification comprises the consequence, alerting the user or provider of the penalty incurred at the current or potential violation of the required performance level.

At step 260, provided a plurality of instances of the threshold not being satisfied are detected, the plurality of instances are prioritized according to the rule as received at step 220. As with step 220, it should be appreciated that step 260 is optional. Continuing with the example recited at step 220, two orders (e.g., instances) are received, and the processing of both orders simultaneously will result in the required performance level being violated for both. The rule prioritizes the violations by indicating that the most expensive order will be handled first. Therefore, the most expensive order will be handled first, and the less expensive order will be handled second, minimizing the financial cost the provider must incur.

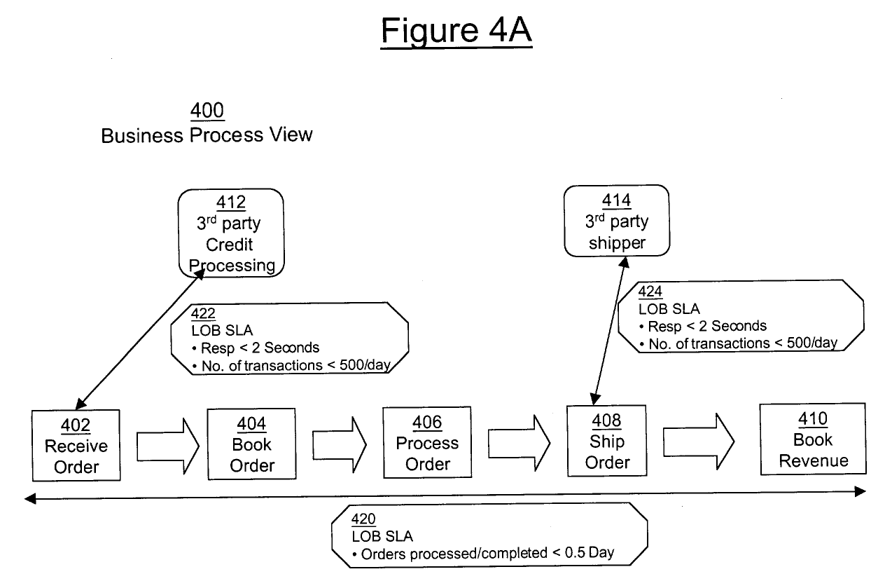

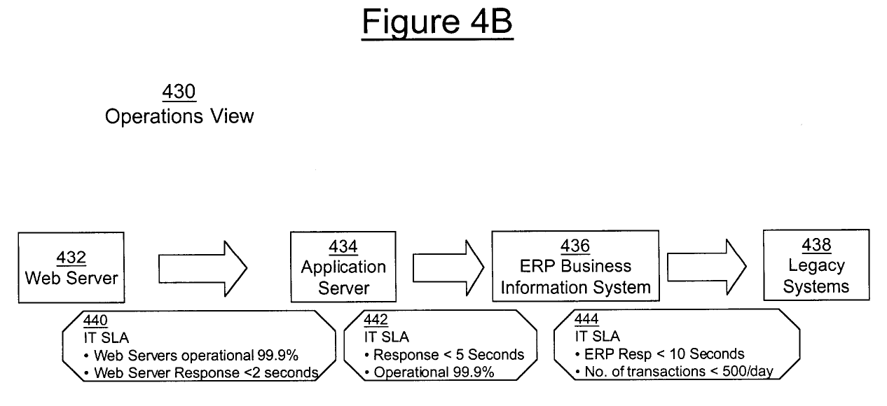

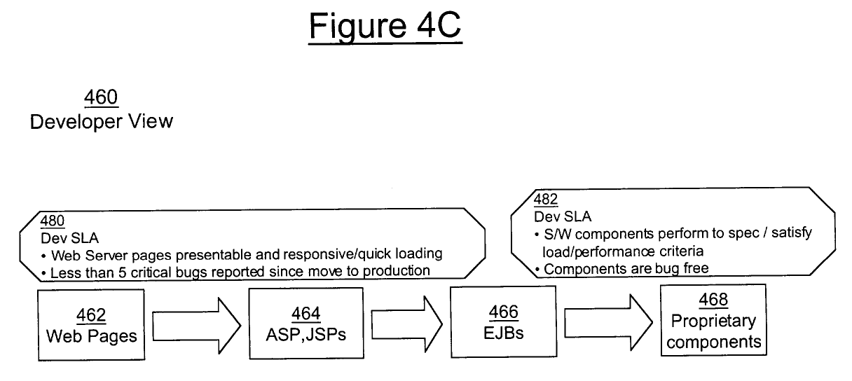

FIGS. 4A-C are block diagrams illustrating a plurality of roles of a managed system. In one embodiment, FIGS. 4A-C illustrate an exemplary managed system implementing Web services to manage a shopping Web site.

FIG. 4A is a block diagram of an exemplary business process view 400 illustrating line of business SLAs in accordance with one embodiment of the present invention. Business process view 400 illustrates an exemplary line of business (LOB) process and corresponding SLAs. Business process view 400 comprises the elements of receive order 402, book order 404, process order 406, ship order 408 and book revenue 410.

In the present example, the LOB has been contracted by an organization to process orders on behalf of the organization. LOB SLA 420 dictates the conditions and consequences between the LOB and the organization. LOB SLA 420 requires the LOB to process every order to completion in less than twelve hours. If the LOB violates the terms of LOB SLA 420, a predetermined consequence will occur, such as a percentage reduction based on the value of unprocessed orders.

The LOB has contracted third party credit processing 412 to handle credit card processing associated with receive order 402. LOB SLA 422 dictates the conditions and consequences between the LOB and third party credit processing 412. LOB SLA 422 requires third party credit processing 412 to provide a response time of less than two seconds and requires the LOB to provide less than 500 transactions per day. If third party credit processing 412 or the LOB violate the terms of LOB SLA 422, a predetermined consequence will occur.

The LOB has contracted third party shipper 414 to handle shipping associated with receive order 402. LOB SLA 424 dictates the conditions and consequences between the LOB and third party shipper 414. LOB SLA 424 requires third party shipper 414 to provide a response time of less than two seconds and requires the LOB to provide less than 500 transactions per day. If shipper 414 or the LOB violate the terms of LOB SLA 424, a predetermined consequence will occur.

It should be appreciated that LOB SLAs 420, 422 and 424 are input into a SLA monitor (e.g., SLA monitor 110 of FIG. 1). The performance of the SLAs is measured against the required performance levels as indicated in the respective LOB SLA. In one embodiment, provided the LOB SLA is violated, a notification is generated indicating the violation. In another embodiment, provided a threshold associated with the LOB SLA is not satisfied, a notification is generated warning of the threshold violation.

FIG. 4B is a block diagram of an exemplary operations view 430 illustrating line of IT SLAs in accordance with one embodiment of the present invention. Operations view 430 illustrates an exemplary IT infrastructure and corresponding SLAs. Operations view 430 comprises the elements of Web server 432, application server 434, enterprise resource planning (ERP) business information system 436, and legacy systems 438.

Continuing the current example, the LOB has contracted operations to provide IT support for the managed system. In one embodiment, operations provides IT infrastructure for the managed system. IT SLAs 440, 442 and 444 dictate the conditions and consequences between the LOB and Operations. Specifically, IT SLA 440 dictates that Web server 432 must be operational 99.9% of the time and the Web server 432 must respond in less than two seconds. Similarly, IT SLA 442 dictates that application server 434 must be operational 99.9% of the time and must respond to requests in less than five seconds. Furthermore, IT SLA 444 dictates that ERP business information system 436 must respond in less than ten seconds while limiting ERP business information system 436 to handling less than 500 transactions per day.

It should be appreciated that IT SLAs 440, 442 and 444 are input into a SLA monitor (e.g., SLA monitor 110 of FIG. 1). The performance of the SLAs is measured against the required performance levels as indicated in the respective IT SLA. In one embodiment, provided the IT SLA is violated, a notification is generated indicating the violation. In another embodiment, provided a threshold associated with the IT SLA is not satisfied, a notification is generated warning of the threshold violation.

FIG. 4C is a block diagram of an exemplary developer view 460 illustrating developer SLAs in accordance with one embodiment of the present invention. Developer view 460 illustrates exemplary development components and corresponding SLAs. Developer view 460 comprises the elements of Web pages 462, Application Service Providers (ASPs) and Java Server Pages (JSPs) 464, Enterprise JavaBeans (EJBs) 466, and proprietary components 468.

Continuing the current example, operations has contracted the developer to provide software development support for the managed system. Developer SLAs 480, and 482 dictate the conditions and consequences between operations and the developer. Specifically, Developer SLA 480 dictates that Web pages 462 must be presentable, responsive and quick loading and that there must be less than five critical bugs. Developer SLA 482 dictates that software components (e.g., ASPs and JSPs 464, EJBs 466 and proprietary components 468) must perform to specifications and satisfy load requirements and that the components are bug free.

It should be appreciated that Developer SLAs 440, 442 and 444 are input into a SLA monitor (e.g., SLA monitor 110 of FIG. 1). The performance of the SLAs is measured against the required performance levels as indicated in the respective Developer SLA. In one embodiment, provided the Developer SLA is violated, a notification is generated indicating the violation. In another embodiment, provided a threshold associated with the Developer SLA is not satisfied, a notification is generated warning of the threshold violation.

Embodiments of the present invention provide a systematic method for monitoring SLAs between two parties. By providing a systematic approach, a particular role can monitor its own SLA performance as well as receive indicators of the performance of another role. For example, if Operations receives notification that IT SLA 442 of FIG. 4B is being violated by having response times of greater than 5 seconds, this may indicate that the software developer may be violating Developer SLA 480 of FIG. 4C. By systematically monitoring performance of SLAs, each role can better manage their own resources and better anticipate the changes in resource allocation by the other roles.

Various embodiments of the present invention, a method for monitoring a managed system, are thus described. While the present invention has been described in particular embodiments, it should be appreciated that the present invention should not be construed as limited by such embodiments, but rather construed according to the below claims.

What is claimed is:

1. A method for monitoring a managed system, said method comprising:
receiving a performance requirement comprising at least one condition and at least one consequence, said condition describing a required performance level of a portion of said managed system and said consequence describing a penalty provided the required performance level is not satisfied;
monitoring system management data of said managed system for an instance of a threshold of said required performance level not being satisfied; and
in response to said threshold not being satisfied, generating a notification.

2. The method as recited in claim 1 wherein said performance requirement is comprised within a service level agreement.

3. The method as recited in claim 1 wherein said threshold is said required performance level of said condition.

4. The method as recited in claim 1 wherein said threshold is associated with said required performance level of said condition, said notification comprising a warning that said condition is at risk of not being satisfied.

5. The method as recited in claim 1 further comprising receiving at least one rule comprising a prioritization scheme for prioritizing a plurality of instances of said threshold not being satisfied.

6. The method as recited in claim 5 further comprising, provided a plurality of instances of said threshold not being satisfied are detected, prioritizing said plurality of instances according to said rule.

7. The method as recited in claim 2 wherein said service level agreement is between a business role and an operations role.

8. The method as recited in claim 2 wherein said service level agreement is between an operations role and a development role.

9. A computer-readable medium having computer-readable program code embodied therein for causing a computer system to perform a method of monitoring enforcement of a service level agreement, said method comprising:
receiving said service level agreement comprising at least one condition and at least one consequence, said condition describing a required performance level of a portion of a managed system and said consequence describing a penalty provided the required performance level is not satisfied;
accessing system management data of said managed system related to said service level agreement;
determining a performance level of said portion of said managed system using said system management data related to said service level agreement;
comparing said required performance level against said performance level for an instance of a threshold of said required performance level not being satisfied; and
in response to said threshold not being satisfied, generating a notification.

10. The computer-readable medium as recited in claim 9 wherein said threshold is said required performance level of said condition.

11. The computer-readable medium as recited in claim 9 wherein said threshold is associated with said required performance level of said condition, said notification comprising a warning that said condition is at risk of not being satisfied.

12. The computer-readable medium as recited in claim 9 further comprising receiving at least one rule comprising a prioritization scheme for prioritizing a plurality of instances of said threshold not being satisfied.

13. The computer-readable medium as recited in claim 12 further comprising, provided a plurality of instances of said threshold not being satisfied is detected, prioritizing said plurality of instances according to said rule.

14. The computer-readable medium as recited in claim 9 wherein said service level agreement is between a business role and an operations role.

15. The computer-readable medium as recited in claim 9 wherein said service level agreement is between an operations role and a development role.

16. A system for monitoring a managed system, said system comprising:
means for receiving a performance requirement comprising at least one condition and at least one consequence, said condition describing a required performance level of a portion of said managed system and said consequence describing a penalty provided the required performance level is not satisfied;
means for accessing system management data of said managed system associated with said performance requirement;
means for comparing system management data of said managed system for an instance of a threshold of said required performance level not being satisfied; and
means for generating an alert in response to said threshold not being satisfied.

17. The system as recited in claim 16 wherein said performance requirement is comprised within a service level agreement.

18. The system as recited in claim 16 wherein said threshold is said required performance level of said condition.

19. The system as recited in claim 16 wherein said threshold is associated with said required performance level of said condition, said alert comprising a warning that said condition is at risk of not being satisfied.

20. The system as recited in claim 17 wherein said service level agreement is between a business role and an operations role.

21. The system as recited in claim 17 wherein said service level agreement is between an operations role and a development role.
